(19) United States
(12) Patent Application Publication
(10) Pub. No.: US 2014/0212562 A1
(43) Pub. Date: Jul. 31, 2014

(54) Food flavouring composition

(71) Applicant: Leon Daniel, Thornhill (CA)

(72) Inventor: Leon Daniel, Thornhill (CA)

(21) Appl. No.: 13/815,066

(22) Filed: Jan. 29, 2013

(51) Int. Cl. A23L 1/236

(52) U.S. Cl. CPC A23L 1/2364
USPC 426/548

(57) ABSTRACT

A food flavouring product for adding a sweet flavour to foods and which contains a mixture of erythritol, inulin of chickory root, gum arabic, an extract of a natural herbal sweetener selected from the group comprising stevia extract and thaumatin extract, ascorbic acid, and lactic acid, and citric acid, in a certain range of predetermined proportions.

The stevia extract is in the form of rebaudioside-A, (stevia glycosides).

This application is based on U.S. application Ser. No. 13/506,716, Filed May 11, 2012, entitled Food Flavouring Composition, inventor Leon Daniel, which in turn was based on U.S. Provisional App. Ser. No. 61/457,593 Filed May 16, 2011, inventor Leon Daniel, title Food Flavouring Composition the priority of which is claimed.

### FIELD OF THE INVENTION

The invention relates to an edible natural sweet-flavouring product for adding to various foods, and in particular to an edible, natural non-toxic, non-allergenic, digestible, sweetener flavouring.

### BACKGROUND OF THE INVENTION

Adding sweet flavour to foods has been carried out with harmless, non-toxic, digestible natural products since biblical times. Honey was the main source.

Some herbal products also have a sweet flavour.

Since the development of the sugar cane industry, plant sugar originating in the cane has been available. However, the extreme degree of processing to which cane sugar is subjected, renders the refined product to some extent harmful.

Also, it can pass through the stomach and small intestine rapidly, with little digestion.

Such undigested cane sugar is believed to pass into the colon where it assists in proliferation of undesirable bacteria.

The principal valuable minerals present in the original cane sugar are removed in refining, and is known as molasses for which there are fewer markets, except as colouring for certain foods and beverages.

Refined cane sugar seems to accumulate in body tissue. It seems to have a possible effect on the production of insulin. It may cause extreme fluctuations in blood sugar. Cane sugar, partly due to its almost universal use in many edible products, may be one factor in the cause of tooth decay. Refined sugar varies in price, as do all commodities, and can have a significant effect on the price of the end product.

For example soda drinks are said to contain two pounds of refined sugar in every case of twenty-four cans. Beverages such as beer also contain large amounts of sugar. Pharmaceutical and health products often contain large proportions of sugar, to render them more palatable to the consumer.

Variations in the price of sugar can thus have a major effect on the cost of such products.

For all these reasons synthetic sugar substitutes of various kinds have been developed, and some are in very wide use. Such products when used as food additives are frequently promoted as being “low in calories” when in fact they may cause the body to accumulate more weight, than if the same food products were sweetened with natural cane sugar. There is a growing concern amongst both health professionals, and consumers that such substitutes are not entirely free from undesirable side effects. Accordingly it is desirable to create a sweetener product, which avoids the use of actual cane sugars, but which is free from undesirable or damaging side effects, and is non-toxic, and harmless.

### BRIEF SUMMARY OF THE INVENTION

Accordingly the invention provides a dry powder food flavouring product for adding a sweet flavour to foods and which contains a mixture of erythritol, inulin of chicory root, gum arabic, an extract of stevia, and a compound selected from ascorbic acid, or lactic acid, or citric acid, in a range of predetermined proportions comprising
Erythritol from 35.0 % to 70.0%
Inulin from Chicory Root from 10.0% to 25.0%
Gum Arabic from 10.0% to 25.0%
Stevia Rebaudiana Leaf Extract from 2.5% to 8.5%
Compound selected from ascorbic and Citric and Lactic Acid from 0.3% to 1.5%

Preferably the stevia extract will be as rebaudioside-A, (stevia glycosides).

In some cases, the use of stevia as a sweetener may be unsuitable or undesirable. This may be due to difficulties in obtaining supply or for example, regulations in the food industry or the like. In these cases, the stevia sweetener portion of the formulation may be replaced by an alternate sweetener, of natural origin. In other cases, it may be that the taste of inhabitants of a particular country or particular group of inhabitants may prefer a taste in which the sweetener portion of the formulation is a combination of a stevia extract, and another natural sweetener. In these cases, the natural sweetener product, under the name of THAUMITIN, may be substituted in whole or in part for the stevia extract.

In some countries or in certain products for example, erythritol is not an acceptable ingredient. In these cases erythritol is omitted and the proportions of the remaining ingredients are changed to provide an acceptable taste.

Various formulations have been developed for different purposes, the details of which are described below.

In these various examples, the other ingredients already described, will normally be incorporated, although in varying proportions, again in the manner described.

The various features of novelty which characterize the invention are pointed out with more particularity in the claims annexed to and forming a part of this disclosure. For a better understanding of the invention, its operating advantages and specific objects attained by its use, reference should be made to the descriptive matter in which there are described preferred embodiments of the invention.

### DESCRIPTION OF A SPECIFIC EMBODIMENT

As explained above the invention provides a natural non-toxic harmless flavouring product for adding a sweet flavour to foods, without side effects.

The sweet-flavouring product contains the following components:

Ingredients: erythritol, soluble food fibers (inulin of chicory root and acacia gum), stevia leaf extract rebaudioside A (or steviol glycosides with rebaudioside A [SG-RS])≧97% and at least one compound selected from ascorbic acid, lactic acid, and citric acid.
Erythritol from 35.0 % to 70.0%
Inulin from Chicory Root from 10.0% to 25.0%
Gum Arabic from 10.0% to 25.0%
Stevia Rebaudiana Leaf Extract Rebaudioside A≧95% from 2.5% to 8.5%
Compound selected from Ascorbic Acid and Citric Acid and Lactic Acid from 0.3% to 1.5%

Preferably the stevia extract will be as rebaudioside-A, (stevia glycosides).

Erythritol ((2R,3S)-butane-1,2,3,4-tetraol) is a sugar alcohol (or polyol) that has been approved for use as a food additive in the United States and throughout much of the world. It occurs naturally in some fruits and fermented foods. At the industrial level, it is produced from glucose by fermentation with a yeast, Moniliella pollinis. It is 60-70% as sweet as table sugar yet it is almost non-caloric, does not affect blood sugar, does not cause tooth decay, and is partially absorbed by the body, and is excreted in urine and feces. It is less likely to cause gastric side-effects than other sugar alcohols due to its unique digestion pathway.

Gum arabic, also known as acacia gum, chaar gund, char goond, or meska, is a natural gum made of hardened sap taken from two species of the acacia tree; Acacia senegal and Acacia seyal. The gum is harvested commercially from wild trees throughout the Sahel from Senegal and Sudan to Somalia, although it has been historically cultivated in Arabia and West Asia. Gum arabic, a complex mixture of polysaccharides and glycoproteins, is used primarily in the food industry as a stabilizer. It is edible and has E number E414. Gum arabic is a key ingredient in traditional lithography and is used in printing, paint production, glue, cosmetics and various industrial applications, including viscosity control in inks and in textile industries, although less expensive materials compete with it for many of these roles. Middle Eastern populations use the natural gum to make a chilled, sweetened, and flavored gelato-like dessert.

Acacia gum's mixture of saccharides and glycoproteins gives it the properties of a glue and binder which is edible by humans. Other substances have replaced it in situations where toxicity is not an issue, as the proportions of the various chemicals in gum arabic vary widely and make it unpredictable. Still, it remains an important ingredient in soft drink syrups, “hard” gummy candies such as gumdrops, marshmallows, M&M's (trade mark) chocolate candies and edible glitter, a very popular, modern cake-decorating staple

Inulins are a group of naturally occurring polysaccharides produced by many types of plants. They belong to a class of fibers known as fructans. Inulin is used by some plants as a means of storing energy and is typically found in roots or rhizomes. Most plants that synthesize and store inulin do not store other materials such as starch.

Inulin is increasingly used in processed foods because it has unusually adaptable characteristics. Its flavour ranges from bland to subtly sweet (approx. 10% sweetness of sugar/sucrose). It can be used to replace sugar, fat, and flour. This is advantageous because inulin contains 25-35% of the food energy of carbohydrates (starch, sugar). In addition to being a versatile ingredient, inulin has many health benefits. Inulin increases calcium absorption and possibly magnesium absorption, while promoting the growth of intestinal bacteria. In terms of nutrition, it is considered a form of soluble fiber and is sometimes categorized as a prebiotic. Due to the body's limited ability to process fructans, inulin has minimal increasing impact on blood sugar, and—unlike fructose—is not insulemic and does not raise triglycerides, making it considered suitable for diabetics and potentially helpful in managing blood sugar-related illnesses.

### Stevia

Stevia rebaudiana, commonly known as sweetleaf, sweet leaf, sugarleaf, or simply stevia, is widely grown for its sweet leaves. As a sweetener and sugar substitute, stevia's taste has a slower onset and longer duration than that of sugar, although some of its extracts may have a bitter or licorice-like aftertaste at high concentrations.

steviol glycoside extracts have up to 300 times the sweetness of sugar.

Stevia has a negligible effect on blood glucose, and is attractive as a natural sweetener to people on carbohydrate-controlled diets.

Ascorbic acid, citric acid and lactic acid are well known edible compounds, found in many natural foods.

### Product Applications:

The sweetener product of the invention is recommended as a natural multipurpose food additive for use in preparation of the traditional, functional and organic foods and natural health products—to sweeten the final products and improve the texture, consistency and freshness, and also to extend the shelf life of the final products.

Suggested Percentage: 2.5% or less of the total weight of the finished product, or as needed.

### Product Uses/Purposes:

as a natural sweetener to substitute for cane sugar and for synthetic sugar substitutes;
as a texture and consistency improver and a freshness stabilizer of the finished product;
as an extender of shelf life by decreasing a water activity of the finished product.

### Product Benefits:

highly effective as a replacement for cane sugar and for synthetic sugar substitutes;
provides natural sweetness;
enhances and improves the taste and flavor of the finished product;
no undesirable aftertaste and bitterness;
no chemical agents;
improves texture and retains the freshness of the finished product for a long time;
highly resistant to aggressive media: high temperature, acidity, alcohols;
not subject to fermentation by microorganisms;
does not undergo to caramelization during baking or frying processes, resulting in improved appearance of the finished product which is lighter than the same product in which cane sugar is used;
excellent flow ability of the mixture;
may be added at any processing stage;
is cold water soluble;
extends the shelf life of the finished product;
helps to minimize intake of cane sugar and avoids intake of artificial ingredients thereby contributing to a healthy balanced diet;
safer for diabetics and can be used to sweeten foods to provide a sugar-free diet;
brings a rich source of soluble food fibers that is very important for a digestive health;
can be used as part of a calorie reduced diet to achieve weight loss;
reduces tooth decay due to cane sugars.

Experiments to determine an acceptable range of proportions have been conducted as follows;

### Experiment 1:

We measured the following components by weight as follows:

| | | |
|---|---|---|
| Erythritol | g | 750 |
| Rebaudioside A, 97% (powder) | g | 85 |
| Inulin of Chicory Root | g | 80 |
| Gum Arabic | g | 70 |
| Citric Acid and/or Lactic Acid, or Ascorbic Acid | g | 15 |

| | |
|---|---|
| Total: | 1000 |

These components were blended in an electrical blender without the mixing devices inside (i.e. paddles, blades), with keeping the following steps and conditions:

1) the components were started to put into the blender in accordance with the principle—first add the smallest amount;
2) all added components were mixed about 3-5 minutes by use a slow speed of the blender.

The dry blended compound was then tested by mixing 1 g in a 250 ml of tea. The test could show the following:

a) the taste was very excessively sweet and felt an undesirable bitter aftertaste and unfavorable lingering;
b) at the same time, could felt sour taste;
c) some samples of tea were less sweeter than other samples of the same tea, that means that the blending time by use a slow speed of the blender, should be more than 5 minutes.

The proportions of components were then changed.

### Experiment 2:

Same procedures and steps as for Experiment 1, except a mixing time—6-8 minutes.

| | | |
|---|---|---|
| Erythritol | g | 732 |
| Inulin of Chicory Root | g | 90 |
| Acacia Gum | g | 85 |
| Rebaudioside A, 97% (powder) | g | 80 |
| Citric Acid and/or Lactic Acid, or Ascorbic Acid | g | 13 |

| | |
|---|---|
| Total: | 1000 |

The test could show the following:

a) the taste was excessively sweet and felt an undesirable bitter aftertaste and unfavorable lingering;
b) at the same time, could felt sour taste but less than in Experiment 1;
c) some samples of tea were less sweeter than other samples of the same tea but better than in Experiment 1; that means that this blending time is better;
d) an increasing of the amount of Inulin and Gum Arabic were positively influenced on the taste.

The proportions of components were then changed.

### Experiment 3:

Same procedures and steps as for Experiment 1, except changing the amount of components.

| | | |
|---|---|---|
| Erythritol | g | 730 |
| Inulin of Chicory Root | g | 95 |
| Gum Arabic | g | 90 |
| Rebaudioside A, 97% (powder) | g | 75 |
| Citric Acid and/or Lactic Acid, or Ascorbic Acid | g | |

| | |
|---|---|
| Total: | 1000 |

The test could show the following:

a) the taste was more than sufficiently sweet and felt an undesirable bitter aftertaste and unfavorable lingering, but less than in Experiment 2;
b) at the same time, could felt sour taste but much less than in Experiment 2;
c) all samples of tea have been sweeten equally than in Experiment 2; that means that the blending time 8-10 minutes by use a slow speed of the blender is enough to get an equality of the blending of components;
d) the taste of dry blended compound was better in the case of use Citric Acid and/or Lactic Acid.

The proportions of components were then changed.

### Experiment 4:

Same procedures and steps as for Experiment 1, except changing the amount of components.

| | | |
|---|---|---|
| Erythritol | g | 700 |
| Inulin of Chicory Root | g | 115 |
| Gum Arabic | g | 106 |
| Rebaudioside A, 97% (powder) | g | 70 |
| Citric Acid and/or Lactic Acid, or Ascorbic Acid | g | 9 |

| | |
|---|---|
| Total: | 1000 |

The test could show the following:

a) the taste was more than sufficiently sweet and felt an undesirable bitter aftertaste and unfavorable lingering but less than in Experiment 3;
b) at the same time, the sour taste could felt a little bit;
c) all samples of tea have been sweeten equally;
d) the taste of dry blended compound was better in the case of use Citric Acid and/or Lactic Acid.

The proportions of components were then changed.

### Experiment 5:

Same procedures and steps as for Experiment 1, except changing the amount of components.

| | | |
|---|---|---|
| Erythritol | g | 650 |
| Inulin of Chicory Root | g | 143 |
| Gum Arabic | g | 134 |
| Rebaudioside A, 97% (powder) | g | 65 |
| Citric Acid and/or Lactic Acid, or Ascorbic Acid | g | 8 |

| | |
|---|---|
| Total: | 1000 |

The test could show the following:

a) the taste was more than sufficiently sweet but less than in Example 4, and felt an undesirable bitter aftertaste and unfavorable lingering but much less than in Experiment 4;
b) at the same time, the sour taste was not felt;
c) all samples of tea have been sweeten equally;
d) the taste of dry blended compound was better in the case of use Citric Acid and/or Lactic Acid.

The proportions of components were then changed.

### Experiment 6:

Same procedures and steps as for Experiment 1, except changing the amount of components.

| | | |
|---|---|---|
| Erythritol | g | 450 |
| Inulin of Chicory Root | g | 258 |
| Gum Arabic | g | 249 |
| Rebaudioside A, 97% (powder) | g | 35 |
| Citric Acid and/or Lactic Acid, or Ascorbic Acid | g | 8 |

| | |
|---|---|
| Total: | 1000 |

The test could show the following:

a) the taste was not sufficiently sweet and felt without a bitterness but with an unfavorable aftertaste than in Experiment 5;
b) at the same time, the sour taste was not felt;
c) all samples of tea have been sweeten equally;
d) the taste of dry blended compound was better in the case of use Citric Acid and/or Lactic Acid.

The proportions of components were then changed.

### Experiment 7:

Same procedures and steps as for Experiment 1, except changing the amount of components.

| | | |
|---|---|---|
| Erythritol | g | 500 |
| Inulin of Chicory Root | g | 228 |
| Gum Arabic | g | 219 |
| Rebaudioside A, 97% (powder) of PURE CIRCLE USA, INC. | g | 45 |
| Citric Acid and/or Lactic Acid, or Ascorbic Acid | g | 8 |

| | |
|---|---|
| Total: | 1000 |

The test could show the following:

a) the taste was not sufficiently sweet and felt without a bitterness but with much less an unfavorable aftertaste than in Experiment 6;
b) at the same time, the sour taste was not felt;
c) all samples of tea have been sweeten equally;
d) the taste of dry blended compound was better in the case of use Citric Acid and/or Lactic Acid.

The proportions of components were then changed.

### Experiment 8:

Same procedures and steps as for Experiment 1, except changing the amount of components.

| | | |
|---|---|---|
| Erythritol | g | 557 |
| Inulin of Chicory Root | g | 190 |
| Gum Arabic | g | 190 |
| Rebaudioside A, 97% (powder) | g | 55 |
| Citric Acid and/or Lactic Acid, or Ascorbic Acid | g | 8 |

| | |
|---|---|
| Total: | 1000 |

The test could show the following:

a) the taste was sufficiently sweet and felt without a bitterness and without any an unfavorable aftertaste than in the previous Experiments;
b) at the same time, the sour taste was not felt;
c) II samples of tea have been sweeten equally;
d) the taste of dry blended compound was better in the case of use Citric Acid and/or Lactic Acid; at the same time, in the case of use Ascorbic Acid the taste was better than in the previous Experiments.

The proportions of components were then left unchanged.

This product is named SWEET BROOK (trade mark).

The Technical and Technological Conditions:

1. The particle sizes of the ingredients should be equal or approximately same. This condition should preferably be kept because of more uniform the particle sizes of the ingredients distribution.
2. The Blender had no mixing devices inside (i.e. paddles, blades); it should be constructed on the principle of “Drum Tumbler”. At the same time, the Blender could have some paddles or stirring tools but only combined with the Grinder, including the Fluidized Paddle Blender.

### The Technological Steps and Instructions:

1. Start to add first into the Blender the smallest amount of the ingredients. This condition must be kept because of more effective and equable of the mixing of the ingredients.
2. Mix all added ingredients about 5-10 minutes but no less than 5 minutes and no more than 10 minutes. This condition must be kept to prevent an insufficient or over mixing. The mixing time is depending on the kind of the blending system.

As a result of these experiments it has been determined that

There are three main formulae based on the above formulation, namely:

### Version #1

| Ingredients, % | Min | Max |
|---|---|---|
| Erythritol | 35.0 | 70.0 |
| Inulin from Chicory Root | 10.0 | 25.0 |
| Gum Arabic | 10.0 | 25.0 |
| Stevia Rebaudiana Leaf Extract Rebaudioside A ≧95% | 2.5 | 8.5 |
| Citric Acid | 0.3 | 1.5 |

### Version #2

| Ingredients, % | Min | Max |
|---|---|---|
| Erythritol | 35.0 | 70.0 |
| Inulin from Chicory Root | 10.0 | 25.0 |
| Gum Arabic | 10.0 | 25.0 |
| Stevia Rebaudiana Leaf Extract Rebaudioside A ≧95% | 2.5 | 8.5 |
| Lactic Acid | 0.3 | 1.5 |

### Version #3

| Ingredients, % | Min | Max |
|---|---|---|
| Erythritol | 35.00 | 70.00 |
| Inulin from Chicory Root | 10.00 | 25.00 |
| Gum Arabic | 10.00 | 25.00 |
| Stevia Rebaudiana Leaf Extract Rebaudioside A ≧95% | 2.50 | 8.50 |
| Lactic Acid | 0.15 | 0.75 |
| Citric Acid | 0.15 | 0.75 |

A particularly preferred formulation, suitable for most consumer tastes is as follows.

| Ingredients | % |
|---|---|
| Erythritol | 55.7 |
| Inulin from Chicory Root | 19.0 |
| Gum Arabic | 19.0 |
| Stevia Rebaudiana Leaf Extract Rebaudioside A 97% | 5.5 |
| Citric Acid, or lactic acid or ascorbic acid | 0.8 |
| Total: | 100.0 |

Examples of Recipes using the sweet-flavouring product are shown below:

### Example 1

### Tea Drink

| Name of Ingredients | % |
|---|---|
| Hot Water | 98.38 |
| Tea (for example: black, green, or herb mixtures, .) | 0.98 |
| sweet-flavouring product | 0.64 |
| Total: | 100.00 |

### Example 2

### Coffee Drink

| Name of Ingredients | % |
|---|---|
| Hot Water | 92.88 |
| Coffee (powder) | 6.19 |
| Sweet-flavouring product | 0.93 |
| Total: | 100.00 |

### Example 3

### Herbal Tea

| Name of Ingredients | % |
|---|---|
| Green Tea Leaves | 35.0 |
| Blackcurrant Leaves | 25.5 |
| Elder | 16.5 |
| Fruit Fennel | 8.0 |
| Rose Hip | 8.0 |
| Sweet-flavouring product | 6.5 |
| Blackcurrant flavor | 0.5 |
| Total: | 100.00 |

### Example 4

### Fruit Filling

| Name of Ingredients | % |
|---|---|
| Cherry (flesh) | 65.00 |
| Water | 24.47 |
| Kelp Extract | 5.00 |
| sweet-flavouring product | 2.50 |
| Carrageenan | 1.80 |
| Pectin | 0.50 |
| Cherry flavor | 0.30 |
| Locust Bean Gum | 0.30 |
| Xanthan Gum | 0.10 |
| Citric Acid | 0.03 |
| Total: | 100.00 |

### Example 5

### Sweet Bun Recipe

| Name of Ingredients | % |
|---|---|
| All Purpose Flour | 64.10 |
| Water | 25.64 |
| Margarine | 7.70 |
| Yeast (pressed) | 1.60 |
| Salt | 0.64 |
| Sweet-flavouring product | 0.32 |
| Total: | 100.00 |

### Quality and Safety Characteristics

| | | |
|---|---|---|
| Parameter Name | Unit | Standard Tolerance |

Physical-chemical Parameters

| | | |
|---|---|---|
| Moisture | % | maximum 5.0% |
| Solubility | | 100% cold water soluble |
| Mesh | | minimum 90% through US |
| | | No. 20 screen |
| Precipitation (residue) | | none detected |
| Appearance | | homogeneous, non-crystalline |
| Color | | blanched almond to white |
| Flavor | | Absent |
| Taste | | sweet, delectable, no |
| | | aftertaste, no bitterness |
| Ph | | maximum 4.20 |
| Sweetness | | approx. 35-45 times |
| | | sweeter than sugar |
| Total Soluble Food Fibers | % | 37.50-38.50 |
| Fructo-oligosaccharides (FOS) | % | 18.50-19.50 |
| Erythritol | % | 53.00-57.00 |
| Rebaudioside A (≧97% purity) | % | 5.30-5.90 |

Microbiological Parameters

| | | |
|---|---|---|
| QMAFAnM (TPC) | CFU/g | not >5.0 × 10⁴ |
| Yeast | CFU/g | not >100 |
| Mold | CFU/g | not >100 |
| Total Coliforms | | negative in 0.1 g |
| E. Coli | | negative in 1.0 g |
| Pathogenics, including | | negative in 25.0 g |
| Salmonella | | |
| Listeria monocytogenes | | negative in 25.0 g |

As discussed briefly above, there are some circumstances in which the use of stevia extracts as the natural sweetening component of the mixture are preferably reduced, and for some countries, eliminated all together. To meet these requirements, three further formulations have been developed and tested. These formulations are named: SWEET POESY, SWEET AMBROSIA, and SWEET WAVE.

All three names are Trade Marks of the Applicant.

The first two produces, namely Sweet Poesy and Sweet Ambrosia contain modified sweeteners which are combinations of a stevia extract and Thaumatin. These sweeteners are incorporated in varying proportions, and combined in varying proportions with other ingredients, for the purpose of providing satisfactory sweeteners for various common consumables. The third product Sweet Wave has been developed exclusively using Thaumatin as a sweetener, without any Stevia extract being present. The details and examples and testing of these various products are as follows

### The Different Names of the Same Ingredient and Chemical Formula

Thaumatin—mixture of two main proteins isolated from the Katemfe Fruit (Thaumatococcus daniellii Bennett) of West Africa, Naturally Occurring Sweetener and Flavor Enhancer. Thaumatine, Thaumatina, Talin, Thaumatin B-Recombinant.

Proper Name Thaumatin—there may be several related proteins in the plant, but there are two main forms: Thaumatin I and Thaumatin II. Thaumatin I is composed of 207 amino acids, with molecular weight 22,204. Thaumatin II is synthesized as a precursor protein of 235 amino acids; the first 22 amino acids and the last 6 amino acids are apparently cleaved to produce a protein the same size as Thaumatin I (207 amino acids) and 98% identical to Thaumatin I.

Thaumatins have an isoelectric point around 11-12. Their tertiary structures are maintained by 8 disulfide linkages.

Purposes: Nutritive Sweetener/Natural Sugar Substitute, Flavour Enhancer, Stabilizing Agent, Sweetening Agent, Blood Sugar and Cholesterol Corrector.

### Examples of Use of SWEET AMBROSIA

### Example 1

### Tea Drink

| Name of Ingredients | % |
|---|---|
| Hot Water | 98.937 |
| Tea (different kinds of tea: black, green, | 0.980 |
| or herb mixtures, etc.) | |
| Sweet Ambrosia | 0.083 |
| Total: | 100.000 |

### Example 2

### Coffee Drink

| Name of Ingredients | % |
|---|---|
| Hot Water | 93.69 |
| Coffee (powder) | 6.19 |
| Sweet Ambrosia | 0.12 |
| Total: | 100.00 |

### Example 3

### Herbal Tea (Dry Blend)

| Name of Ingredients | % |
|---|---|
| Green Tea Leaves | 38.35 |
| Blackcurrant Leaves | 27.80 |
| Elder | 16.50 |
| Fruit Fennel | 8.00 |
| Rose Hip | 8.00 |
| Sweet Ambrosia | 0.85 |
| Flavour “Blackcurrant” | 0.50 |
| Total: | 100.00 |

### Example 4

### Fruit Filling

| Name of Ingredients | % |
|---|---|
| Cherry (flesh) | 65.00 |
| Water | 26.44 |
| Kelp Extract | 5.00 |
| Carrageenan | 1.80 |
| Sweet Ambrosia | 0.53 |
| Pectin | 0.50 |
| Flavour “Cherry” | 0.30 |
| Locust Bean Gum | 0.30 |
| Xanthan Gum | 0.10 |
| Citric Acid | 0.03 |
| Total: | 100.00 |

### Example 5

### Sweet Bun

| Name of Ingredients | % |
|---|---|
| All Purpose Flour | 64.265 |
| Water | 25.750 |
| Margarine | 7.700 |
| Yeast (pressed) | 1.600 |
| Salt | 0.640 |
| Sweet Ambrosia | 0.045 |
| Total: | 100.000 |

### The Formula of SWEET AMBROSIA

### Experimental Work

### Experiment 1:

We measured the following components by weight as follows:

| | | |
|---|---|---|
| Erythritol | g | 50.0 |
| Inulin from Chicory Root | g | 21.1 |
| Gum Arabic | g | 21.1 |
| Rebaudioside A, ≧97% (powder) | g | 5.5 |
| Thaumatin, ≧97% | g | 1.5 |
| Lactic Acid, or/and Citric Acid | g | 0.8 |

| | |
|---|---|
| Total: | 100.0 |

These components were blended in an electrical blender without the mixing devices inside (i.e. paddles, blades), with keeping the following steps and conditions:

1) the components were started to put into the blender in accordance with the principle—first add the smallest amount; all ingredients were added, except Thaumatin, and started to blend;
2) all added components were mixed about 5 minutes by use a slow speed of the blender and during a mixing slowly, step by step, was added Thaumatin; this procedure is required to achieve an equal distribution of Thaumatin in the blend, because of very small amount of use of its.

The dry blended compound was then tested by mixing 0.25 g in a 250 ml of tea. The test could show the following:

a) the taste was very excessively sweet and felt an undesirable little bitter but over concentrated aftertaste and unfavorable lingering;
b) the taste of dry blended compound was softer and nicer in the case of use Lactic Acid, however Citric Acid could be used as well;
c) some samples of tea were less sweeter than other samples of the same tea, that means that the blending time by use a slow speed of the blender, should be more than 5 minutes.

The amount of components should be changed.

### Experiment 2:

Same procedures and steps as for Experiment 1, except a mixing time—6-7 minutes and changing the amount of components.

| | | |
|---|---|---|
| Erythritol | g | 50.0 |
| Inulin from Chicory Root | g | 21.2 |
| Gum Arabic | g | 21.2 |
| Rebaudioside A, ≧97% (powder) | g | 6.0 |
| Thaumatin, ≧97% | g | 0.8 |
| Lactic Acid | g | 0.8 |

| | |
|---|---|
| Total: | 100.0 |

The test could show the following:

a) the taste was less excessively sweet, but felt more undesirable bitter aftertaste and unfavorable lingering than in Experiment 1;
b) an increasing of the amount of Rebaudioside A and a decreasing of the amount of Thaumatin were positively influenced on the sweetness level of the blend, but negatively were influenced on the taste;
c) some samples of tea were less sweeter than other samples of the same tea but better than in Experiment 1; that means that this blending time is better;

The amount of components should be changed.

### Experiment 3:

Same procedures and steps as for Experiment 1, except a mixing time—8-10 minutes and changing the amount of components.

| | | |
|---|---|---|
| Erythritol | g | 54.4 |
| Inulin from Chicory Root | g | 19.0 |
| Gum Arabic | g | 19.0 |
| Rebaudioside A, ≧97% (powder) | g | 6.0 |
| Thaumatin, ≧97% | g | 0.8 |
| Lactic Acid | g | 0.8 |

| | |
|---|---|
| Total: | 100.0 |

The test could show the following:

a) the taste was excessively sweet and felt an undesirable bitter aftertaste and unfavorable lingering but less than in Experiment 2;
b) an increasing of the amount of Erythritol was positively influenced on the taste of the blend, but not sufficiently;
c) all samples of tea have been sweeten equally than in Experiment 2; that means that the blending time 8-10 minutes by use a slow speed of the blender is enough to get an equality of the blending of Thaumatin among all components of the blend;

The amount of components should be changed.

### Experiment 4:

Same procedures and steps as for Experiment 1, except changing the amount of components.

| | | |
|---|---|---|
| Erythritol | g | 57.2 |
| Inulin from Chicory Root | g | 18.0 |
| Gum Arabic | g | 18.0 |
| Rebaudioside A, ≧97% (powder) | g | 5.0 |
| Thaumatin, ≧97% | g | 1.0 |
| Lactic Acid | g | 0.8 |
| Total: | | 100.0 |

The test could show the following:

a) the taste was not sufficiently sweet and felt without a bitterness and unfavorable aftertaste than in Experiment 3;
b) an increasing of the amount of Erythritol was more positively influenced on the taste and sweetness level of the blend, but not enough;
c) an increasing of the amount of Thaumatin and a decreasing of the amount of Rebaudioside A were more positively influenced on the sweetness level and the taste of the blend;
d) all samples of tea have been sweeten equally.

The amount of components should be changed.

### Experiment 5:

Same procedures and steps as for Experiment 1, except changing the amount of components.

| | | |
|---|---|---|
| Erythritol | g | 62.9 |
| Inulin from Chicory Root | g | 15.0 |
| Gum Arabic | g | 15.0 |
| Rebaudioside A, ≧97% (powder) | g | 5.2 |
| Thaumatin, ≧97% | g | 1.1 |
| Lactic Acid, or/and Citric Acid | g | 0.8 |
| Total: | | 100.0 |

The test could show the following:

a) the taste was sufficiently sweet and felt without a bitterness and without any an unfavorable aftertaste than in the previous Experiments;
b) the taste of dry blended compound was better in the case of use Lactic Acid; at the same time, in the case of use Citric Acid the taste was better than in the previous Experiments;
c) all samples of tea have been sweeten equally;

The amount of components should not be changed.

The three main purposes for use of Thaumatin:

1. The experiments could show that in the case of use Thaumatin the blend does have much higher level of sweetness and allows much more: a) to improve the taste of the finished products and b) to enhance and enrich a flavor formation of the finished products than without of use Thaumatin. As example, this blend named SWEET AMBROSIA could be compared with the blend named SWEET BROOK.
2. The stevia leaf extracts such as glycosides Rebaudioside A and Stevioside currently are not allowed to be used as food ingredients, for example in Canada, but Thaumatin is allowed. Therefore one of the three new blends, named SWEET WAVE, has been developed without of use Rebaudioside A.
3. Some product applications are not allowing use Erythritol. Therefore one of the three new blends, named SWEET POESY, has been developed without of use Erythritol.

### The Technical and Technological Conditions:

1. The particle sizes of the ingredients should be equal or approximately same. This condition must be kept because of more uniform the particle sizes of the ingredients distribution.
2. The Blender should have no any mixing devices inside (i.e. paddles, blades); it should be constructed on the principle of “Drum Tumbler”. At the same time, the Blender could have some paddles or stirring tools but only combined with the Grinder, including the Fluidized Paddle Blender.
3. The Blending system should have some sprinkling device for dry ingredients or other method with the similar principle which will allow an equal distribution of Thaumatin in the blend during the mixing process.

### The Technological Steps and Instructions:

1. Start to add first into the Blender the smallest amount of the ingredients. This condition must be kept because of more effective and equable of the mixing of the ingredients.
2. Mix all added ingredients, except Thaumatin, about 8-10 minutes but no less than 8 minutes and no more than 10 minutes, and add Thaumatin slowly, step by step, by use some sprinkling device for dry ingredients or other method with the similar principle. The time mentioned above must be kept to prevent an insufficient or over mixing. The mixing time is depending on the kind of the blending system.

### Examples of Use of SWEET POESY

### Example 1

### Tea Drink

| Name of Ingredients | % |
|---|---|
| Hot Water | 98.937 |
| Tea (different kinds of tea: black, green, or herb mixtures, etc.) | 0.970 |
| Sweet Poesy | 0.093 |
| Total: | 100.000 |

### Example 2

### Coffee Drink

| Name of Ingredients | % |
|---|---|
| Hot Water | 93.59 |
| Coffee (powder) | 6.19 |
| Sweet Poesy | 0.22 |
| Total: | 100.00 |

### Example 3

### Herbal Tea (Dry Blend)

| Name of Ingredients | % |
|---|---|
| Green Tea Leaves | 38.30 |
| Blackcurrant Leaves | 27.75 |
| Elder | 16.50 |
| Fruit Fennel | 8.00 |
| Rose Hip | 8.00 |
| Sweet Poesy | 0.95 |
| Flavour “Blackcurrant” | 0.50 |
| Total: | 100.00 |

### Example 4

### Fruit Filling

| Name of Ingredients | % |
|---|---|
| Cherry (flesh) | 65.00 |
| Water | 26.34 |
| Kelp Extract | 5.00 |
| Carrageenan | 1.80 |
| Sweet Poesy | 0.63 |
| Pectin | 0.50 |
| Flavour “Cherry” | 0.30 |
| Locust Bean Gum | 0.30 |
| Xanthan Gum | 0.10 |
| Citric Acid | 0.03 |
| Total: | 100.00 |

### Example 5

### Sweet Bun

| Name of Ingredients | % |
|---|---|
| All Purpose Flour | 64.255 |
| Water | 25.750 |
| Margarine | 7.700 |
| Yeast (pressed) | 1.600 |
| Salt | 0.640 |
| Sweet Poesy | 0.055 |
| Total: | 100.000 |

### The Formula of SWEET POESY

### Experimental Work

### Experiment 1:

We measured the following components by weight as follows:

| | | |
|---|---|---|
| Inulin from Chicory Root | g | 55.5 |
| Gum Arabic | g | 37.5 |
| Rebaudioside A, ≧97% (powder) | g | 5.4 |
| Thaumatin, ≧97% | g | 0.8 |
| Lactic Acid, or/and Citric Acid | g | 0.8 |
| Total: | | 100.0 |

These components were blended in an electrical blender without the mixing devices inside (i.e. paddles, blades), with keeping the following steps and conditions:

1) the components were started to put into the blender in accordance with the principle—first add the smallest amount; all ingredients were added, except Thaumatin, and started to blend;
2) all added components were mixed about 5 minutes by use a slow speed of the blender and during a mixing slowly, step by step, was added Thaumatin; this procedure is required to achieve an equal distribution of Thaumatin in the blend, because of very small amount of use of its.

The dry blended compound was then tested by mixing 0.25 g in a 250 ml of tea. The test could show the following:

a) the taste was insufficiently sweet and felt a little undesirable aftertaste because of missing Erythritol and an incorrect amount of Rebaudioside A and Thaumatin and proportions of Inulin from Chicory Root and Gum Arabic;
b) the taste of dry blended compound was softer and nicer in the case of use Lactic Acid, however Citric Acid could be used as well;
c) some samples of tea were less sweeter than other samples of the same tea, that means that the blending time by use a slow speed of the blender, should be more than 5 minutes.

The amount of components should be changed.

### Experiment 2:

Same procedures and steps as for Experiment 1, except a mixing time—6-7 minutes and changing the amount of components.

| | | |
|---|---|---|
| Inulin from Chicory Root | g | 51.5 |
| Gum Arabic | g | 41.5 |
| Rebaudioside A, ≧97% (powder) | g | 5.2 |
| Thaumatin, ≧97% | g | 1.0 |
| Lactic Acid, or/and Citric Acid | g | 0.8 |
| Total: | | 100.0 |

The test could show the following:

a) the taste was more sweet than in Experiment 1 but not enough and felt approximately same little undesirable aftertaste as in Experiment 1;
b) an increasing of the amount of Thaumatin was more positively influenced on the sweetness level of the blend than in Experiment 1, but was not enough;
c) the changed proportions of Inulin from Chicory Root and Gum Arabic could allow more positively to influence on the taste of the blend than in Experiment 1;
d) some samples of tea were less sweeter than other samples of the same tea but better than in Experiment 1; that means that this blending time is better;

The amount of components should be changed.

### Experiment 3:

Same procedures and steps as for Experiment 1, except a mixing time—8-10 minutes and changing the amount of components.

| | | |
|---|---|---|
| Inulin from Chicory Root | g | 51.0 |
| Gum Arabic | g | 41.0 |
| Rebaudioside A, ≧97% (powder) | g | 5.5 |
| Thaumatin, ≧97% | g | 1.7 |
| Lactic Acid, or/and Citric Acid | g | 0.8 |
| Total: | | 100.0 |

The test could show the following:

a) the taste was more sweet than in Experiment 2 but not enough and felt a little more undesirable aftertaste than in Experiment 2;
b) an increasing of the amount of Thaumatin and Rebaudioside A were more positively influenced on the taste of the blend than in Experiment 2, but such amount of Thaumatin could occur an “over taste”;
c) the changed proportions of Inulin from Chicory Root and Gum Arabic could allow more positively to influence on the taste of the blend than in Experiment 2;
d) all samples of tea have been sweeten equally than in Experiment 2; that means that the blending time 8-10 minutes by use a slow speed of the blender is enough to get an equality of the blending of Thaumatin among all components of the blend;

The amount of components should be changed.

### Experiment 4:

Same procedures and steps as for Experiment 1, except changing the amount of components.

| | | |
|---|---|---|
| Inulin from Chicory Root | g | 48.0 |
| Gum Arabic | g | 44.0 |
| Rebaudioside A, ≧97% (powder) | g | 5.8 |
| Thaumatin, ≧97% | g | 1.4 |
| Lactic Acid, or/and Citric Acid | g | 0.8 |
| Total: | | 100.0 |

The test could show the following:

a) the taste was not sufficiently sweet and felt a little bitterness and an unfavorable aftertaste than in Experiment 3;
b) an increasing of the amount of Rebaudioside A was little negatively influenced on the taste of the blend;
c) a decreasing of the amount of Thaumatin was negatively influenced on the sweetness level and the taste of the blend;
d) the changed proportions of Inulin from Chicory Root and Gum Arabic could allow more positively to influence on the taste of the blend than in Experiment 3;
e) all samples of tea have been sweeten equally.

The amount of components should be changed.

### Experiment 5:

Same procedures and steps as for Experiment 1, except changing the amount of components.

| | | |
|---|---|---|
| Inulin from Chicory Root | g | 46.0 |
| Gum Arabic | g | 46.0 |
| Rebaudioside A, ≧97% (powder) | g | 5.6 |
| Thaumatin, ≧97% | g | 1.6 |
| Lactic Acid, or/and Citric Acid | g | 0.8 |
| Total: | | 100.0 |

The test could show the following:

a) the taste was sufficiently sweet and felt without a bitterness and without any an unfavorable aftertaste than in the previous Experiments;
b) the same amounts of Inulin from Chicory Root and Gum Arabic could show that the taste of the blend is much better than in the previous Experiments;
c) the taste of dry blended compound was better in the case of use Lactic Acid; at the same time, in the case of use Citric Acid the taste was better than in the previous Experiments;
d) all samples of tea have been sweeten equally;

The amount of components should not be changed.

The three main purposes for use of Thaumatin:

1. The experiments could show that in the case of use Thaumatin the blend does have much higher level of sweetness and allows much more: a) to improve the taste of the finished products and b) to enhance and enrich a flavor formation of the finished products than without of use Thaumatin. As example, this blend in this case SWEET AMBROSIA could be compared with the blend named SWEET BROOK.
2. The stevia leaf extracts such as glycosides Rebaudioside A and Stevioside currently are not allowed to be used as food ingredients in Canada, but Thaumatin is allowed. Therefore one of the three new blends, named SWEET WAVE, has been developed without of use Rebaudioside A.
3. Some product applications are not allowing use Erythritol. Therefore one of the three new blends, named SWEET POESY, has been developed without of use Erythritol.

### The Technical and Technological Conditions:

1. The particle sizes of the ingredients should be equal or approximately same. This condition must be kept because of more uniform the particle sizes of the ingredients distribution.
2. The Blender should have no any mixing devices inside (i.e. paddles, blades); it should be constructed on the principle of “Drum Tumbler”. At the same time, the Blender could have some paddles or stirring tools but only combined with the Grinder, including the Fluidized Paddle Blender.
3. The Blending system should have some sprinkling device for dry ingredients or other method with the similar principle which will allow an equal distribution of Thaumatin in the blend during the mixing process.

### The Technological Steps and Instructions:

1. Start to add first into the Blender the smallest amount of the ingredients. This condition must be kept because of more effective and equable of the mixing of the ingredients.
2. Mix all added ingredients, except Thaumatin, about 8-10 minutes but no less than 8 minutes and no more than 10 minutes, and add Thaumatin slowly, step by step, by use some sprinkling device for dry ingredients or other method with the similar principle. The time mentioned above must be kept to prevent an insufficient or over mixing. The mixing time is depending on the kind of the blending system.

### The Formula of SWEET POESY

### Final Version

| | | |
|---|---|---|
| Inulin from Chicory Root | g | 46.0 |
| Gum Arabic | g | 46.0 |
| Rebaudioside A, ≧97% (powder) | g | 5.6 |
| Thaumatin, ≧97% | g | 1.6 |
| Lactic Acid, or/and Citric Acid | g | 0.8 |
| Total: | | 100.0 |

### The Instructions:

1. The particle sizes of the ingredients should be equal or approximately same. This condition is very important!
2. The Blender could have some paddles or stirring tools combined with the grinder, including the Fluidized Paddle Blender.
3. Start to put first into the Blender the smallest amount of the ingredients, except Thaumatin. This condition must be kept!
4. Mix all added ingredients about 10 minutes and during a mixing sprinkle Thaumatin. This condition must be kept!
5. During preparation of the Samples should be kept the same amount of the ingredients in accordance with the formula mentioned above. These Samples have only one difference between them: the different kinds of acids.

### Examples of Use of SWEET WAVE

### Example 1

### Tea Drink

| Name of Ingredients | % |
|---|---|
| Hot Water | 98.912 |
| Tea (different kinds of tea: black, green, or herb mixtures, etc.) | 0.980 |
| Sweet Wave | 0.108 |
| Total: | 100.000 |

### Example 2

### Coffee Drink

| Name of Ingredients | % |
|---|---|
| Hot Water | 93.44 |
| Coffee (powder) | 6.19 |
| Sweet Wave | 0.37 |
| Total: | 100.00 |

### Example 3

### Herbal Tea (Dry Blend)

| Name of Ingredients | % |
|---|---|
| Green Tea Leaves | 38.25 |
| Blackcurrant Leaves | 27.65 |
| Elder | 16.50 |
| Fruit Fennel | 8.00 |
| Rose Hip | 8.00 |
| Sweet Wave | 1.10 |
| Flavour “Blackcurrant” | 0.50 |
| Total: | 100.00 |

### Example 4

### Fruit Filling

| Name of Ingredients | % |
|---|---|
| Cherry (flesh) | 65.00 |
| Water | 26.19 |
| Kelp Extract | 5.00 |
| Carrageenan | 1.80 |
| Sweet Wave | 0.78 |
| Pectin | 0.50 |
| Flavour “Cherry” | 0.30 |
| Locust Bean Gum | 0.30 |
| Xanthan Gum | 0.10 |
| Citric Acid | 0.03 |
| Total: | 100.00 |

### Example 5

### Sweet Bun

| Name of Ingredients | % |
|---|---|
| All Purpose Flour | 64.260 |
| Water | 25.730 |
| Margarine | 7.700 |
| Yeast (pressed) | 1.600 |
| Salt | 0.640 |
| Sweet Wave | 0.070 |
| Total: | 100.000 |

### The Formula of SWEET WAVE

### Experimental Work

### Experiment 1:

We measured the following components by weight as follows:

| | | |
|---|---|---|
| Erythritol | g | 87.5 |
| Inulin from Chicory Root | g | 8.0 |
| Gum Arabic | g | 3.4 |
| Thaumatin ≧97% | g | 1.1 |
| Total: | | 100.0 |

These components were blended in an electrical blender without the mixing devices inside (i.e. paddles, blades), with keeping the following steps and conditions:

1) the components were started to put into the blender in accordance with the principle—first add the smallest amount; all ingredients were added, except Thaumatin, and started to blend;
2) all added components were mixed about 5 minutes by use a slow speed of the blender and during a mixing slowly, step by step, was added Thaumatin; this procedure is required to achieve an equal distribution of Thaumatin in the blend, because of very small amount of use.

The dry blended compound was then tested by mixing 0.5 g in a 250 ml of tea. The test could show the following:

a) the taste was excessively sweet and felt an undesirable over concentrated aftertaste and a little unfavorable lingering;
b) the undesirable aftertaste was occurred because of an incorrect amount of Erythritol and proportions of Inulin from Chicory Root and Gum Arabic;
c) the taste of dry blended compound was also insufficiently soft;
d) some samples of tea were less sweeter than other samples of the same tea, that means that the blending time by use a slow speed of the blender, should be more than 5 minutes.

The amount of components should be changed.

### Experiment 2:

Same procedures and steps as for Experiment 1, except a mixing time—6-7 minutes and changing the amount of components.

| | | |
|---|---|---|
| Erythritol | g | 87.8 |
| Inulin from Chicory Root | g | 8.0 |
| Gum Arabic | g | 3.0 |
| Thaumatin ≧97% | g | 1.2 |
| Total: | | 100.0 |

The test could show the following:

a) the taste was excessively sweet, but felt more undesirable over concentrated aftertaste and unfavorable lingering than in Experiment 1;
b) an increasing of the amount of Thaumatin and Erythritol were positively influenced on the sweetness level of the blend, but negatively were influenced on the taste;
c) the changed amount of Gum Arabic could not allow positively to influence on the taste of the blend than in Experiment 1;
d) the taste of dry blended compound was again insufficiently soft;
e) some samples of tea were less sweeter than other samples of the same tea but better than in Experiment 1; that means that this blending time is better;

The amount of components should be changed.

### Experiment 3:

Same procedures and steps as for Experiment 1, except a mixing time—8-10 minutes and changing the amount of components.

| | | |
|---|---|---|
| Erythritol | g | 85.2 |
| Inulin from Chicory Root | g | 8.0 |
| Gum Arabic | g | 5.0 |
| Thaumatin ≧97% | g | 1.0 |
| Lactic Acid, or/and Citric Acid | g | 0.8 |
| Total: | | 100.0 |

The test could show the following:

a) the taste was less excessively sweet and felt less undesirable over concentrated aftertaste and unfavorable lingering than in Experiment 2;
b) a decreasing of the amount of Erythritol and Thaumatin were more positively influenced on the taste of the blend, but not sufficiently;
c) the changed proportions of Inulin from Chicory Root and Gum Arabic could allow more positively to influence on the taste of the blend than in Experiments 1 and 2;
d) the taste of dry blended compound was softer and nicer in the case of use Lactic Acid, however Citric Acid could be used as well;
e) all samples of tea have been sweeten equally than in Experiment 2; that means that the blending time 8-10 minutes by use a slow speed of the blender is enough to get an equality of the blending of Thaumatin among all components of the blend;

The amount of components should be changed.

### Experiment 4:

Same procedures and steps as for Experiment 1, except changing the amount of component.

| | | |
|---|---|---|
| Erythritol | g | 61.7 |
| Inulin from Chicory Root | g | 18.0 |
| Gum Arabic | g | 18.0 |
| Thaumatin ≧97% | g | 1.5 |
| Lactic Acid, or/and Citric Acid | g | 0.8 |
| Total: | | 100.0 |

The test could show the following:

a) the taste was not sufficiently sweet as in Experiment 3, but felt without an undesirable over concentrated aftertaste and unfavorable aftertaste than in Experiment
b) a more decreasing of the amount of Erythritol was more positively influenced on the taste of the blend, but not enough;
c) an increasing of the amount of Thaumatin was more positively influenced on the sweetness level and the taste of the blend;
d) the taste of dry blended compound was softer and nicer in the case of use Lactic Acid, however Citric Acid could be used as well;
e) all samples of tea have been sweeten equally.

The amount of components should be changed.

### Experiment 5:

Same procedures and steps as for Experiment 1, except changing the amount of component.

| | | |
|---|---|---|
| Erythritol | g | 77.1 |
| Inulin from Chicory Root | g | 10.0 |
| Gum Arabic | g | 10.0 |
| Thaumatin ≧97% | g | 2.1 |
| Lactic Acid, or/and Citric Acid | g | 0.8 |
| Total: | | 100.0 |

The test could show the following:

a) the taste was sufficiently sweet and felt without a bitterness and without any an unfavorable aftertaste than in the previous Experiments;
b) a more increasing of the amount of Erythritol and Thaumatin than in Experiment 4 and less decreasing of the amount of Erythritol and Thaumatin than in Experiments 1, 2 and 3, was much more positively influenced on the taste and sweetness level of the blend;
c) the same amounts of Inulin from Chicory Root and Gum Arabic could show that the taste of the blend is much better than in the previous Experiments;
d) the taste of dry blended compound was better in the case of use Lactic Acid; at the same time, in the case of use Citric Acid the taste was better than in the previous Experiments;
e) all samples of tea have been sweeten equally;

The amount of components should not be changed.

The three main purposes for use of Thaumatin:

1. The experiments could show that in the case of use Thaumatin the blend does have much higher level of sweetness and allows much more: a) to improve the taste of the finished products and b) to enhance and enrich a flavor formation of the finished products than without of use Thaumatin.
2. The stevia leaf extracts such as glycosides Rebaudioside A and Stevioside currently are not allowed to be used as food ingredients, for example in Canada, but Thaumatin is allowed. Therefore one of the three new blends, named SWEET WAVE, has been developed without of use Rebaudioside A.
3. Some product applications are not allowing use Erythritol. Therefore one of the three new blends, named SWEET POESY, has been developed without of use Erythritol.

### The Technical and Technological Conditions:

1. The particle sizes of the ingredients should be equal or approximately same. This condition must be kept because of more uniform the particle sizes of the ingredients distribution.
2. The Blender should have no any mixing devices inside (i.e. paddles, blades); it should be constructed on the principle of “Drum Tumbler”. At the same time, the Blender could have some paddles or stirring tools but only combined with the Grinder, including the Fluidized Paddle Blender.
3. The Blending system should have some sprinkling device for dry ingredients or other method with the similar principle which will allow an equal distribution of Thaumatin in the blend during the mixing process.

### The Technological Steps and Instructions:

1. Start to add first into the Blender the smallest amount of the ingredients. This condition must be kept because of more effective and equable of the mixing of the ingredients.
2. Mix all added ingredients, except Thaumatin, about 8-10 minutes but no less than 8 minutes and no more than 10 minutes, and add Thaumatin slowly, step by step, by use some sprinkling device for dry ingredients or other method with the similar principle. The time mentioned above must be kept to prevent an insufficient or over mixing. The mixing time is depending on the kind of the blending system.

The foregoing is a description of a preferred embodiment of the invention which is given here by way of example only. The invention is not to be taken as limited to any of the specific features as described, but comprehends all such variations thereof as come within the scope of the appended claims.

What is claimed is:

1. A natural food flavouring product for adding a sweet flavour to foods and which contains a combination of erythritol, inulin of chicory root, gum arabic, an extract of stevia, and a compound selected from the group, comprising: ascorbic acid, lactic acid, and citric acid in the following range of predetermined proportions, namely;
Erythritol from 35.0% to 70.0%
Inulin from Chicory Root from 10.0% to 25.0%
Gum Arabic from 10.0% to 25.0%
Stevia Rebaudiana Leaf Extract Rebaudioside A≧95% from 2.5% to 8.5%
Compound selected from ascorbic acid and Citric and Lactic Acid from 0.3% to 1.5%.

2. A natural food flavouring product as claimed in claim 1 wherein the stevia extract is in the form of rebaudioside-A, (stevia glycosides).

3. A natural food flavouring product as claimed in claim 2 wherein the compounds are in the following proportions namely;

| Ingredients | % |
|---|---|
| Erythritol | 55.7 |
| Inulin from Chicory Root | 19.0 |
| Gum Arabic | 19.0 |
| Stevia Rebaudiana Leaf Extract Rebaudioside A 97% | 5.5 |
| A compound selected from the group comprising | 0.8 |
| Citric Acid, or lactic acid or ascorbic acid | |
| Total: | 100.0 |

4. A natural food flavouring product as claimed in claim 3 wherein the components are in the following proportions namely;

| Ingredients | % |
|---|---|
| Erythritol | 55.7 |
| Inulin from Chicory Root | 19.0 |
| Gum Arabic | 19.0 |
| Stevia Rebaudiana Leaf Extract Rebaudioside A 97% | 5.5 |
| Citric Acid, | 0.8 |
| Total: | 100.0 |

5. A natural food flavouring product as claimed in claim 3 wherein the components are present in the following proportions namely;

| Ingredients | % |
|---|---|
| Erythritol | 55.7 |
| Inulin from Chicory Root | 19.0 |
| Gum Arabic | 19.0 |
| Stevia Rebaudiana Leaf Extract Rebaudioside A 97% | 5.5 |
| Lactic Acid | 0.8 |
| Total: | 100.0 |

6. A natural food flavouring product as claimed in claim 3 wherein the components are in the following proportions namely;

| Ingredients | % |
|---|---|
| Erythritol | 55.7 |
| Inulin from Chicory Root | 19.0 |
| Gum Arabic | 19.0 |
| Stevia Rebaudiana Leaf Extract Rebaudioside A 97% | 5.5 |
| Citric Acid, | 0.4 |
| Lactic acid | 0.4 |
| Total: | 100.0 |

7. A natural food flavouring product by adding sweet flavour to foods and which contain a combination on Erythritol, Inulin from Chicory Root and Gum Arabic and an extract of a natural herbal sweetening product, and a compound selected from the group comprising Ascorbic Acid, Lactic Acid and Citric Acid in the following predetermined proportions, namely:
Erythritol from 35.0% to 70.0%
Inulin from Chicory Root from 10.0% to 25.0%
Gum Arabic from 10.0% to 25.0%
Natural Herbal Sweetener from 2.5% to 8.5%
Compound selected from ascorbic acid and Citric and Lactic Acid from 0.3% to 1.5%.

8. A natural food flavouring product as claimed in claim 7 wherein the natural sweetener is selected from the group comprising an extract of stevia, and an extract of thaumatin.

9. A natural food flavouring product as claimed in claim 8 wherein the compounds are in the following proportions, namely:

| Ingredients % | Min | Max |
|---|---|---|
| Erythritol | 45.0 | 80.0 |
| Inulin from Chicory Root | 10.0 | 25.0 |
| Gum Arabic from Resins of Acacia Tree | 10.0 | 25.0 |
| Rebaudioside A, ≧97% (powder) - extract of Stevia | 2.2 | 8.2 |
| Rebauldiana Leaf | | |
| Thaumatin, ≧97% - extract of African Fruit Katemfe | 0.1 | 4.1 |
| Lactic Acid | 0.3 | 1.5 |

10. A natural food flavouring product as claimed in claim 8 wherein the compounds are in the following proportions, namely:

| Ingredients, % | Min | Max |
|---|---|---|
| Inulin from Chicory Root | 30.0 | 60.0 |
| Gum Arabic from Resins of Acacia Tree | 30.0 | 60.0 |
| Rebaudioside A, ≧97% (powder) - extract of Stevia | 2.6 | 8.6 |
| Rebauldiana Leaf | | |
| Thaumatin, ≧97% - extract of African Fruit Katemfe | 0.6 | 4.6 |
| Lactic Acid | 0.3 | 1.5 |

11. A natural food flavouring product as claimed in claim 8 wherein the compounds are in the following proportions, namely:

| Ingredients, % | Min | Max |
|---|---|---|
| Erithritol | 50.0 | 90.0 |
| Inulin from Chicory Root | 5.0 | 20.0 |
| Gum Arabic from Resins of Acacia Tree | 5.0 | 20.0 |
| Thaumtin, ≧97% - extract of African Fruit Katemfe | 1.1 | 5.1 |
| Lactic Acid | 0.3 | 1.5 |
